(19) United States
(12) Patent Application Publication
(10) Pub. No.: US 2004/0189209 A1
(43) Pub. Date: Sep. 30, 2004

(54) High pressure mercury vapor discharge lamp, and lamp unit

(76) Inventors: Makoto Kai, Katano-shi (JP); Kiyoshi Takahashi, Kyotanabe-shi (JP); Shinichiro Hataoka, Neyagawa-shi (JP); Yuriko Kaneko, Nara-shi (JP); Makoto Horiuchi, Sakurai-shi (JP); Tsuyoshi Ichibakase, Takatsuki-shi (JP); Tomoyuki Seki, Takatsuki-shi (JP); Yumi Suzuki, Hirakata-shi (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(21) Appl. No.: 10/486,190

(22) PCT Filed: Apr. 25, 2003
(86) PCT No.: PCT/JP03/05405

(30) Foreign Application Priority Data
May 23, 2002 (JP) 2002-149007

(51) Int. Cl. H01J 17/20

(52) U.S. Cl. 313/642

(57) ABSTRACT

A high-pressure mercury-vapor discharge lamp according to the present invention includes: an emission tube, which is made of quartz glass and which has a substantially ellipsoidal inner space; at least mercury and a rare gas, which are sealed in the inner space of the emission tube; and at least two electrodes, which are arranged in the inner space of the emission tube so as to face each other. The lamp satisfies W≧150 watts, P≧250 atm, t≦5 mm and rl≦0.0103×W−0.00562×P−0.316×rs+0.615×t+1.93, where W [watts] is the power of the lamp during its lighting operation, P [atm] is an operating pressure in the inner space of the emission tube, rs [mm] is the shorter radius of the inner space, rl [mm] is the longer radius of the inner space (where rl≧rs), and t [mm] is the thickness of a swollen portion that defines the inner space.

### TECHNICAL FIELD

The present invention relates to a high-pressure mercury-vapor discharge lamp and a lamp unit, and more particularly relates to a high-pressure mercury-vapor discharge lamp, which can radiate bright light at an extra-high pressure and which is not breakable easily.

### BACKGROUND ART

In a mercury lamp, as the pressure of mercury increases after the lamp has been lit, the spectral distribution thereof changes from a line spectrum into a continuous spectrum and the luminance thereof also increases. A high-pressure mercury-vapor discharge lamp provides a high luminance and has been used in an exposing radiation source for semiconductor fabrication equipment. However, if the high-pressure mercury-vapor discharge lamp is used as a more intense light source for a projector, for example, then the pressure of mercury (i.e., the operating pressure) needs to be further increased.

A conventional high-pressure mercury-vapor discharge lamp is disclosed in Japanese Laid-Open Publication No. 6-52830, for example. This high-pressure mercury-vapor discharge lamp includes a lamp envelope of quartz glass, a pair of tungsten electrodes arranged within the discharge space of the lamp envelope, and predetermined amounts of mercury, halogen and a rare gas that have been sealed in the discharge space. The discharge space has an ellipsoidal shape. While operating, this lamp dissipates a power (i.e., a lamp power) of 70 W to 150 W. This prior art document describes that the sizes of the ellipsoidal discharge space, including the size in the discharge path direction (i.e., the longer diameter of the ellipsoid), the maximum diameter that passes the discharge path (i.e., the shorter diameter of the ellipsoid), the maximum outer diameter of the lamp envelope, and the length of the discharge path, should be defined within their predetermined ranges.

The prior art document also teaches that a lot of luminous flux is ensured, and the temperature inside of the lamp envelope can fall within a predetermined temperature range, by defining the lamp power within the range of 70 W to 150 W. According to this document, the reason is that if an area with a temperature exceeding the predetermined temperature range was present in the discharge space, then the halogen cycle, produced by the predetermined amount of halogen sealed in, would no longer work, thereby possibly blackening the envelope, eroding the electrodes and shortening the lamp life. These are the problems to be overcome by the subject matter described in the prior art document identified above.

Japanese Laid-Open Publication No. 2-148561 discloses another conventional high-pressure mercury-vapor discharge lamp. This prior art document also discloses a lamp including a discharge vessel, tungsten electrodes and predetermined amounts of mercury and halogen just like Japanese Laid-Open Publication No. 6-52830 identified above, and teaches that the mercury should have a vapor pressure that is higher than 200 bar and that the bulb wall loading should be greater than 1 W/mm². The reasons why these settings are adopted are substantially the same as those described in Japanese Laid-Open Publication No. 6-52830 identified above. More specifically, its object is to ensure a lot of luminous flux and to prevent the envelope walls from being blackened by tungsten evaporating from the electrodes by operating the lamp within the predetermined ranges.

However, the lamp disclosed in Japanese Laid-Open Publication No. 2-148561 has an elongated and narrow discharge vessel and has a lamp power of 50 W. Accordingly, the longer the lamp is lit continuously, the more insufficient the lamp power becomes to obtain a lot of luminous flux. In addition, the temperature inside of the discharge vessel becomes too low to avoid the blackening phenomenon.

Japanese Laid-Open Publication No. 2001-283782 discloses a high-pressure mercury-vapor discharge lamp with a lamp power of 180 W or more. In this lamp, predetermined amounts of mercury and halogen are sealed and the inside diameter and thickness of the maximum diameter portion of the emission tube and the interelectrode distance are defined so as to satisfy a predetermined relationship. According to this document, the predetermined relationship is preferably satisfied because a lamp satisfying that relationship showed good results in tests on optical characteristics and lamp life. In the lamp of which the test results are shown in Japanese Laid-Open Publication No. 2001-283782, according to Table 1 of this document, if the amount of mercury sealed in is 0.25 mg/mm³, which is the upper limit of the predetermined range, the lamp power is calculated approximately 200 W and the operating pressure is calculated approximately 250 atm. That is to say, it is understood that the highest allowable operating pressure of this lamp is around 250 atm.

Recently, light sources for projectors are required to have an even higher optical output, increased efficiency and decreased sizes. If a high-pressure mercury-vapor discharge lamp is used as such a light source, there are some problems that are not solvable by any of the ideas disclosed in the prior art documents identified above.

For example, to increase the optical outputs of lamps by increasing the total luminous flux, the number of lamps with rated powers increases. Specifically, a growing number of lamps have powers exceeding 150 W, e.g., in the range of 200 W to 300 W.

To increase the efficiency, it is effective to increase the luminous efficacy of the discharge emission in the visible range by raising the operating pressure of the lamp being lit. In view of such a consideration, an operating pressure of 250 atm or more is recently demanded. Such an increase in operating pressure is also needed to shorten the interelectrode distance (i.e., to shorten the arc length). When a high-pressure mercury-vapor discharge lamp is used as a light source for a projector, a shortened interelectrode distance increases the optical efficiency during the projection operation. For example, Japanese Laid-Open Publication No. 6-52830 discloses a lamp with a lamp power of 130 W to 150 W and an interelectrode distance of 1.8 mm to 2.0 mm. For the reasons described above, even a lamp with a power of 200 W to 300 W is strongly required to achieve an interelectrode distance of 1.0 mm to 1.5 mm.

In shortening the interelectrode distance, the operating pressure is increased, because the voltage applied per unit length between the electrodes is proportional to the operating pressure. If the interelectrode distance was shortened while the lamp power and operating pressure are unchanged (e.g., when the amount of mercury sealed in a unit volume of the emission tube is constant), then the lamp voltage would decrease and the lamp current would increase accordingly. The increase in lamp current, in turn, would place a thermally excessive load on the discharge electrodes, thus shortening the life of the lamp. Furthermore, the lighting circuit would have an increased maximum allowable current, thus requiring additional safety measures. For these reasons, the increase in lamp current is not preferable.

Meanwhile, as the casing of a projector or any other product has reduced its sizes, it has become increasingly necessary to further reduce the sizes of the lamps.

As the lamp increases its power and operating pressure and decreases its sizes, it has become increasingly important to take some measures against the breakage of lamps. A number of countermeasures against such breakage of lamps have naturally been proposed. However, each of those countermeasures is supposed to cope with a situation where quartz glass devitrifies, for example, deforms and eventually breaks during a long life of a lamp being lit.

Nevertheless, as the lamp increases its power and operating pressure and decreases its own sizes, the thermal load and pressure load within the emission tube increase so significantly that the lamp may be broken before the quartz glass devitrifies or deforms (more specifically, during the initial stage of the lamp life).

When the present inventors examined the debris of such a broken lamp, the quartz glass was neither devitrified nor deformed at all, but was vertically split into two from a point on the swollen portion of the emission tube thereof. FIG. 7 shows how such breakage happens. The high-pressure mercury-vapor discharge lamp 700 shown in FIG. 7 includes an emission tube (bulb) 101 of quartz glass and side-tube portions 106 extending from the emission tube 101. In each of the side-tube portions 106, a portion of an electrode 102, a piece of metal foil 107 welded with the electrode 102, and a portion of an external lead 108 are embedded.

As can be seen from FIG. 7, the swollen portion 109 of the emission tube 101 is vertically split into two from a point and broken. This is a totally different type of breakage from the conventional one. In the conventional high-pressure mercury-vapor discharge lamps, the inner wall of the emission tube blackens or devitrifies, thus deforming and eventually breaking the emission tube. The breakage shown in FIG. 7 is believed to happen by a quite different mechanism from the conventional one.

In order to overcome the newly arising problems described above, an object of the present invention is to provide a high-pressure mercury-vapor discharge lamp, which is hardly vertically split into two from a point on the swollen portion of the emission tube even when the lamp power and operating pressure are increased.

### DISCLOSURE OF INVENTION

A high-pressure mercury-vapor discharge lamp according to the present invention includes: an emission tube, which is made of quartz glass and which has a substantially ellipsoidal inner space; a gas, which is sealed in the inner space of the emission tube and which includes at least mercury and a rare gas; and at least two electrodes, which are arranged in the inner space of the emission tube so as to face each other. The lamp satisfies W≧150 watts, P≧250 atm, t≦5 mm and rl≦0.0103×W−0.00562×P−0.316×rs+0.615×t+1.93, where W [watts] is the power of the lamp during its lighting operation, P [atm] is an operating pressure in the inner space of the emission tube, rs [mm] is the shorter radius of the inner space, rl [mm] is the longer radius of the inner space (where rl≧rs), and t [mm] is the thickness of a swollen portion that defines the inner space.

In one preferred embodiment, the lamp has an arc length of 2 mm or less.

In another preferred embodiment, the lamp has a tensile stress of 5 N/mm² or less on an inner wall surface of the swollen portion of the emission tube during the lighting operation.

In another preferred embodiment, the lamp satisfies W≧200 watts.

In another preferred embodiment, the lamp further satisfies the relationship 244×rs+111×rl+40.2×t≧4.47×W+138.

In another preferred embodiment, the lamp further includes two side-tube portions, which are coupled to the emission tube. Each of the two side-tube portions includes a columnar portion that extends from the emission tube in an arc length direction. The columnar portion includes a substantially cylindrical first glass portion and a second glass portion, which is provided so as to fill at least a part of the inside of the first glass portion, and has a site to which compressive stress is applied.

In another preferred embodiment, the site to which the compressive stress is applied is one of the second glass portion, a boundary between the second and first glass portions, a part of the second glass portion, which is close to the first glass portion, and a part of the first glass portion, which is close to the second glass portion.

In another preferred embodiment, a strain resulting from a difference in stress between the first and second glass portions is present in the vicinity of the boundary between the first and second glass portions.

In another preferred embodiment, the compressive stress is applied at least partially along the length of the side-tube portions.

Another high-pressure mercury-vapor discharge lamp according to the present invention includes: an emission tube, which is made of quartz glass and which has a substantially ellipsoidal inner space; a gas, which is sealed in the inner space of the emission tube and which includes at least mercury and a rare gas; and at least two electrodes, which are arranged in the inner space of the emission tube so as to face each other. The lamp satisfies W≧150 watts, P≧250 atm and t≦5 mm, where W [watts] is the power of the lamp during its lighting operation, P [atm] is an operating pressure in the inner space of the emission tube, and t [mm] is the thickness of a swollen portion that defines the inner space. The lamp has a tensile stress of 5 N/mm² or less on an inner wall surface of the swollen portion of the emission tube during the lighting operation.

A lamp unit according to the present invention includes: any of the high-pressure mercury-vapor discharge lamps described above; and a reflective mirror for reflecting light that has been emitted from the emission tube of the high-pressure mercury-vapor discharge lamp. The lamp unit is lit such that the longer radius of the inner space of the emission tube is parallel to ground.

### BRIEF DESCRIPTION OF DRAWINGS

FIG. 1 is a view illustrating a high-pressure mercury-vapor discharge lamp according to a first embodiment of the present invention.

FIG. 2(a) is a graph showing a normal stress to be produced in the quartz glass swollen portion of an emission tube according to the first embodiment and

FIG. 2(b) shows a “position”.

FIG. 3 shows an FEM model according to the first embodiment of the present invention.

FIG. 4 shows exemplary results of FEM calculations according to the first embodiment of the present invention.

FIG. 5 shows exemplary results of FEM calculations according to the first embodiment of the present invention.

FIG. 6 is a graph obtained based on the data shown in FIG. 4 and shows a relationship between the stress on the top surface of the emission tube inner space and the longer radius of the emission tube inner space.

FIG. 7 illustrates a conventional high-pressure mercury-vapor discharge lamp, which has been vertically split into two from the swollen portion of the emission tube thereof.

FIG. 8(a) is a cross-sectional view schematically illustrating an overall arrangement for a high-pressure mercury-vapor discharge lamp according to a second embodiment of the present invention, and FIG. 8(b) schematically illustrates a cross-sectional structure of the side-tube portion 2 as taken along the line b-b shown in FIG. 8(a) and as viewed from the emission tube 101.

FIG. 9(a) is a cross-sectional view illustrating a configuration for a lamp 200 including a second glass portion 7 according to the second embodiment of the present invention, and FIG. 9(b) is a cross-sectional view illustrating a configuration for a lamp 200′ including no second glass portion 7.

FIG. 10 is a bar graph showing stress values that were obtained for a lamp according to the present invention.

FIG. 11 is a cross-sectional view illustrating a lamp unit according to an embodiment of the present invention.

### BEST MODE FOR CARRYING OUT THE INVENTION

Embodiment 1

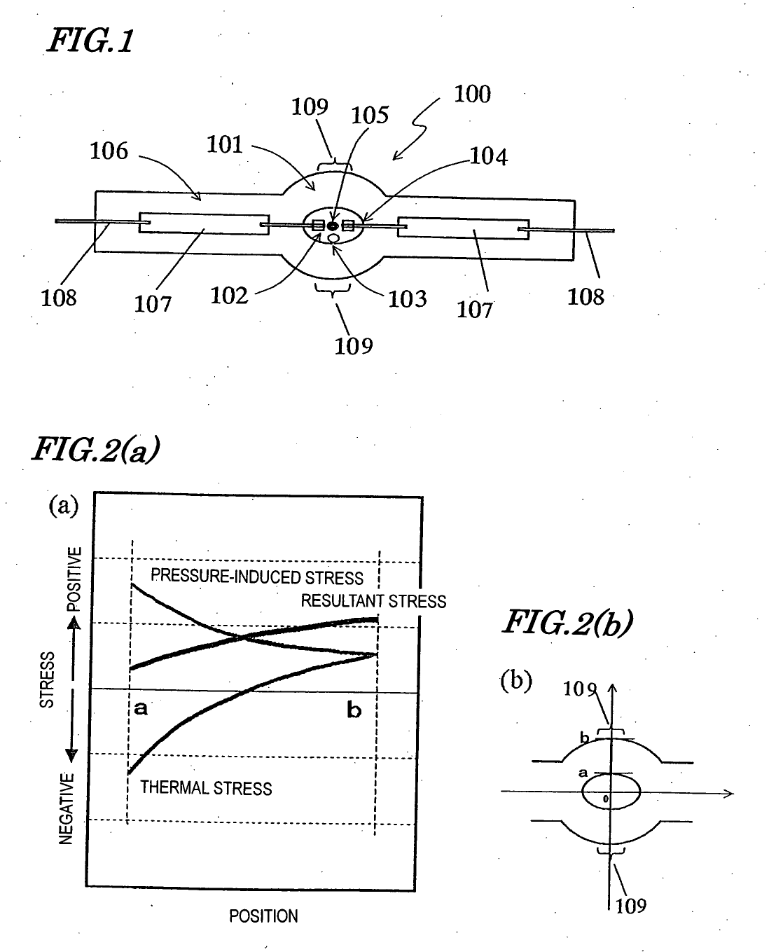

A high-pressure mercury-vapor discharge lamp according to a first embodiment of the present invention will be described with reference to FIG. 1, which is a cross-sectional view showing the structure of a high-pressure mercury-vapor discharge lamp 100 according to this embodiment.

The high-pressure mercury-vapor discharge lamp 100 of this embodiment includes an emission tube 101 made of quartz glass and two side-tube portions 106 extending from the emission tube 101.

The emission tube 101 has an inner space, which functions as a discharge space and which has a substantially ellipsoidal shape. A pair of electrodes 102 protrudes into the inner space of the emission tube 101 and faces each other with a predetermined gap provided between their ends. Arc discharge is generated between the two electrodes 102 and the arc length is defined by the gap between the ends of the electrodes 102. In the inner space of the emission tube 101, mercury 3, halogen (not shown) and a rare gas (not shown) are sealed.

The side-tube portions 106 extend from the emission tube 101 in the arc length direction (i.e., horizontally in FIG. 1) and function as a “sealing member” that maintains the emission tubes 101 airtight. In the side-tube portions 106, portions of the electrodes 102, metal foil pieces 107 that are welded with the electrodes 102, and portions of external leads 108 that are welded with the metal foil pieces 107 so as to be opposed to the electrodes 102, are embedded. In this embodiment, the electrodes 102 are made of tungsten and the metal foil pieces 107 and external leads 108 are made of molybdenum.

A tungsten coil is wound around the end of each of the two electrodes 102, protruding into the inner space of the emission tube 101, to increase the heat capacity.

The lamp power during its lighting operation is represented herein by W [watts], the operating pressure in the inner space of the emission tube is represented herein by P [atm], the shorter radius of the inner space of the emission tube is represented herein by rs [mm], the longer radius of the inner space of the emission tube is represented herein by rl [mm] (where rl≧rs) and the thickness of the swollen portion that defines the inner space of the emission tube is represented herein by t [mm]. Eleven types of lamps with various combinations of these parameters were made and tested to see whether or not the lamps were broken at an early stage of their life. The test results are shown in the following Table 1, in which the broken lamps are indicated by “X” and the non-broken lamps are indicated by “◯”.

TABLE 1

| | 1 | 2 | 3 | 4 | 5 | 6 | 7 | 8 | 9 | 10 | 11 |
|---|---|---|---|---|---|---|---|---|---|---|---|
| W[W] | 150 | 150 | 180 | 200 | 200 | 200 | 270 | 270 | 310 | 310 | 310 |
| P[atm] | 250 | 250 | 350 | 250 | 350 | 350 | 250 | 350 | 350 | 350 | 350 |
| rs[mm] | 2 | 2 | 2.1 | 2.3 | 2.3 | 2.3 | 2.7 | 2.7 | 3 | 3.2 | 3.6 |
| rl[mm] | 3.2 | 3.2 | 3.2 | 3.6 | 3.6 | 3 | 3.6 | 4.1 | 4.1 | 4.1 | 4.1 |
| t[mm] | 2.6 | 3 | 3.4 | 3 | 3.2 | 3.2 | 4 | 4.8 | 3 | 4.8 | 4.8 |
| Result | X | ◯ | ◯ | ◯ | X | ◯ | ◯ | ◯ | X | ◯ | ◯ |

In Table 1, the operating pressure P [atm] is defined by the following generally used empirical equation (Equation 1):

$$Operating pressure P [ atm ] ≡ \frac{Weight [ mg ] of mercury sealed}{Content volume [ {cm}^{3} ] of emission tube} \qquad [ Equation 1 ]$$

The reasons why the operating pressure can be defined by Equation 1 are as follows.

In a very small volume ΔVs [m³] which is defined inside of the emission tube filled with the mercury vapor produced, the ideal gas satisfies the equation of state P·ΔVs=Δns·R·Ts, where P is the pressure [Pa], Δns is the amount of mercury [mol], R is 8.314 [J/Mol/K] and Ts is the temperature [K].

By modifying this equation with P [atm], Δns [mg] and ΔVs [cm³] and by performing integration with respect to the entire content volume (ΣΔn≡n), the following equation can be obtained:

$$P = 4.14 \times {10}^{- 4} \cdot \frac{n}{\sum \frac{Δ Vs}{Ts}} \qquad [ Equation 2 ]$$

In this case, supposing the mercury vapor is uniformly distributed everywhere inside of the emission tube,

$$P = 4.14 \times {10}^{- 4} \cdot T \cdot \frac{n}{V} = A \cdot ( n / V ) \\ ( \sum Δ Vs ≡ V ) \qquad [ Equation 3 ]$$

is satisfied.

The mercury vapor produced inside of the emission tube may have variable temperatures from one position to another, but the pressure applied to the inner wall of the emission tube is a weighted average of the pressures of respective ΔVs. Accordingly, if ΔVs is supposed to have been equally divided, then it is appropriate to replace T in Equation 3 with a weighted Ts average of respective ΔVs with respect to the content volume of the emission tube. A high-pressure mercury-vapor discharge lamp with an interelectrode distance of 1.0 mm to 2.0 mm, which is normally used in a projector, for example, has its intra emission tube temperature distribution represented by a temperature of 6,000 K to 7,000 K at the center of discharge and by a temperature of 1,000 K to 1,500 K on the surface of the inner wall of the emission tube. Accordingly, the weighted average temperature inside of the emission tube is estimated to fall within the range of 2,000 K to 3,000 K. And if this value is substituted for T in Equation 3, then the constant A=0.828 to 1.242, which is close to one. This is why the empirical equation (Equation 1) may be regarded as appropriate.

As for the results of breakage tests shown in Table 1, the lamps that were broken within 6 hours after the aging test was started (i.e., after the lamp was lit) are indicated by “X”. The debris of each of those broken lamps indicated by “X” was checked. As a result, the quartz glass, which was the inner surface of the emission tube, showed no sign of devitrification or blackening. Also, no cracking seemed to have occurred from the electrode sealed portion 104 shown in FIG. 1 (i.e., in the vicinity of the boundary between the electrodes 102 and the emission tube 101). Thus, each of those lamps appeared to have been split into two from a point of the swollen portion 109 of the emission tube.

Based on these test results, we discovered the following.

Specifically, if the lamp has a power of around 100 W and an operating pressure of about 200 atm during its lighting operation as in the prior art, then the structure of the lamp may have only to be determined so as to minimize the devitrification and blackening of the emission tube and resultant shortening of lamp life, which are problems that are solvable even by the prior art. However, if the lamp power rises to 200 W or more and if the operating pressure during the lighting operation is raised to 250 atm or more, which has not yet been experienced by any conventional lamp, it becomes more and more important to prevent the center of the swollen portion of the emission tube from being broken at an early stage of the lamp lighting operation.

To overcome such a newly arising problem, some guidelines for designing a novel lamp such that the emission tube thereof has a mechanical strength that is high enough to bear those increasing thermal and pressure loads during the lamp lighting operation need to be drawn up.

We paid special attention to the stress to be placed on the inner wall of the emission tube of a lamp during its horizontal lighting operation. While a lamp is being lit, a stress resulting from a thermal load (i.e., a thermal stress) and a stress resulting from the pressure of mercury vapor are placed in combination on the inner wall of the emission tube. This thermal stress is caused when the discharge arc 5, located at substantially the center of the emission tube, acts as a heat source. The emission tube of the lamp has a temperature distribution in which the temperature is the highest at the heat source and gradually decreases therefrom substantially concentrically toward the outer surface of the quartz glass. Through the outer surface of quartz glass, a significant quantity of heat is radiated and dissipated into the external air. Accordingly, during the lamp lighting operation, the thermal stress produced within the quartz glass increases concentrically from the inner surface toward the outer surface. Consequently, the thermal stress on the inner surface of the emission tube tends to be “compressed” as compared with the thermal stress on the outer surface thereof.

On the other hand, the pressure-induced stress is caused by the pressure of the mercury vapor that is produced inside of the emission tube during the lamp lighting operation. This stress is the highest on the inner surface of the emission tube and decreases therefrom concentrically toward the outer surface thereof.

As used herein, the “horizontal lighting” refers to a state in which a lamp operates such that the longer radius of the substantially ellipsoidal inner space of the emission tube (i.e., the arc length direction) is kept almost parallel to the ground. In a lamp unit for use in a projector, for example, a reflective mirror for reflecting the light emitted from the emission tube 101 and a horizontally lit lamp are sometimes used in combination. A high-pressure mercury-vapor discharge lamp may be horizontally lit not only when used as a light source for a projector but also when used as an illumination lamp.

FIGS. 2(a) and 2(b) schematically show exemplary distributions of stresses that are produced in the emission tube of a high-pressure mercury-vapor discharge lamp having the structure shown in FIG. 1. The graph of FIG. 2(a) shows the thermal stress placed on the thick swollen portion 109 of the emission tube, the pressure-induced stress, and the resultant stress as the sum of these stresses. In this graph, the abscissa represents a position on a line extending from the inner surface a of the emission tube toward the outer surface b thereof, while the ordinate represents the relative value of the stress. A positive stress represents a tensile stress while a negative stress represents a compressive stress.

As can be seen from FIG. 2, the thermal stress is negative on the inner surface a (i.e., a compressive stress is placed thereon) but increases in the positive direction from the inner surface a toward the outer surface b. The thermal stress has its polarity switched into positive between the inner and outer surfaces a and b and becomes a tensile stress in the vicinity of the outer surface b. On the other hand, the pressure-induced stress is the highest on the inner surface a and decreases from the inner surface a toward the outer surface b. However, this stress is positive in the entire range from the inner surface a to the outer surface b and is always a tensile stress.

The stress caused inside of the quartz glass is the sum of these two stresses. As can be seen from FIG. 2, the gradients of the thermal stress and the pressure-induced stress are steepest on the inner surface a of the emission tube and have opposite polarities. The stress placed on the inner surface a of the emission tube is defined as the difference between the absolute value of the thermal stress and that of the pressure-induced stress, and is very sensitive to variations of these stresses. Accordingly, the stress placed on the inner surface a of the emission tube changes significantly with, and the degree of breakability of the swollen portion of the emission tube is determined by, in what shape the emission tube is designed.

Thus, we paid special attention to the value of the stress placed on the swollen portion 109 of the emission tube, from which cracking is believed to start in case of breakage, and calculated the value of the stress placed on the inner wall surface of the emission tube of the lamp during its lighting operation according to a structural analysis program by a finite element method. The procedure of this calculation will be described below.

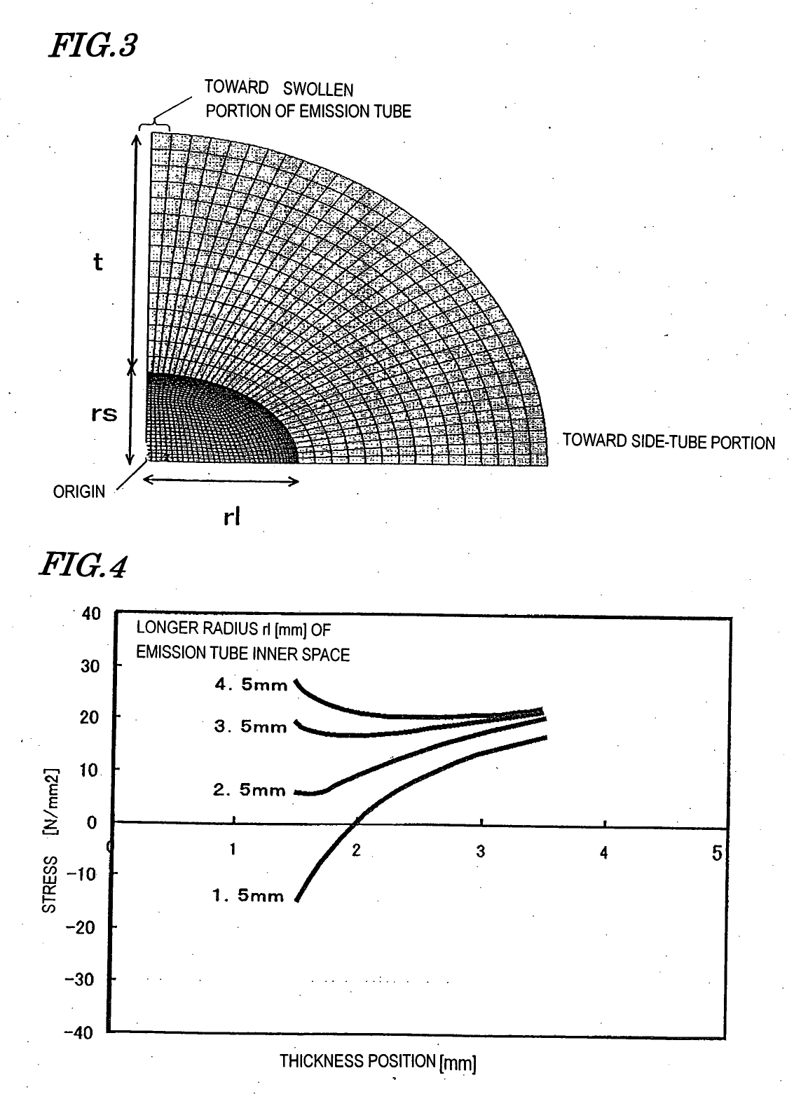

FIG. 3 shows an exemplary model that was used in the FEM. According to this model, the calculation was carried out on an emission tube which is represented as a relatively big ellipsoidal body including a relatively small hollow ellipsoidal body. The cross section of a one-eighth portion of the emission tube is shown in FIG. 3.

Exemplary parameters defining the shape of that model used in the FEM include the shorter radius rs [mm] of the emission tube inner space, the longer radius rl [mm] of the emission tube inner space, and the thickness t [mm] of the swollen portion of the emission tube, where rs≦rl is satisfied.

However, the electrodes 102 shown in FIG. 1 are not included in, but omitted from, the model. This is because judging from how the lamp was actually broken, the cracking did not start from the electrode sealed portion 104 shown in FIG. 1 and therefore, the electrodes were believed to be negligible in calculating the stress. For that reason, we adopted such a model as clearly showing what correlation the stress distribution only in the emission tube as a discharge vessel had with the shape of the emission tube.

The lamp actually had the side-tube portions 106 as shown in FIG. 1. It is imaginable that the shape of these side-tube portions 106 affected the temperature and stress distributions at respective portions of the lamp. According to S. Nakao et al. (S. Nakao et al., Proceedings of IDW '00 LAD 2-4), if the side-tube portions 106 have a rather complicated shape, then the stress concentrated on those portions changes depending on the shape of the side-tube portions 106, which supposes that the cracking leading to the lamp breakage should start from the side-tube portions 106. Accordingly, the breakage described in that document is a different phenomenon from the breakage of the swollen portion of the emission tube to be eliminated by the present invention. In other words, the present invention is particularly beneficial for a lamp in which the problem of possible breakage at the side-tube portions 106 has been resolved.

The conditions that were defined for our calculation will be described in further detail. The calculation was carried out in the following manner. Specifically, first, the temperature distribution within the quartz glass was calculated. Next, the stress distribution was calculated based on the result obtained. This was done in accordance with a normal procedure of a thermal-structural coupled analysis.

The conditions that were defined for the initial temperature distribution calculation were as follows. Specifically, a portion of the energy that was supplied when the lamp was lit and that would be dissipated as thermal energy was uniformly distributed over the entire inner wall surface of the emission tube. The percentage of the energy to be dissipated as the thermal energy when the lamp was lit to the overall energy to be dissipated (i.e., the lamp power) was supposed to be 30% (see Elenbaas, “The High Pressure Mercury Vapour Discharge”, North-Holland Publishing Company, 1951).

In view of the heat to be radiated and dissipated, air regions were provided on the inner and outer surfaces of the emission tube (i.e., at the inner- and outermost peripheries of the model). However, the convection in the air regions was not taken into consideration.

The lamp actually has a mercury vapor region that produces convection inside of the emission tube. However, by dissipating 30% of the lamp power as the thermal energy when the lamp is lit, there is no need to define any mercury vapor region. For that reason, no mercury vapor region is defined according to this model.

The quartz glass had a density of 2,200 kg/m³, a specific heat of 1152.55 J/kgK, and a thermal conductivity of 1.7 W/mK.

The conditions for calculating the stress distribution were defined as follows. Specifically, the calculation was carried out based on the thermal stresses produced by the rise in the temperatures of respective portions of the model from room temperature (18° C.) and on the operating pressure that was uniformly applied onto the inner wall surface of the emission tube. The increases in temperature were calculated based on the previously computed temperature distribution. The physical parameters needed to calculate the stress were set as follows. The quartz glass has a Young's modulus of 73,100 N/mm², a Poisson ratio of 0.17 and a linear expansivity of 5.6×10⁻⁷.

The lamp power W was one of the three conditions of 150 W, 200 W and 300 W; the operating pressure P was one of the three conditions of 250 atm, 350 atm and 450 atm; the shorter radius rs of the emission tube inner space was one of the three conditions of 1.5 mm, 2.5 mm and 3.5 mm; the longer radius rl of the emission tube inner space was one of four that were selected from the group consisting of 1.5 mm, 2.5 mm, 3.5 mm, 4.5 mm, 5.5 mm and 6.5 mm and that consist of the minimum and three other values satisfying rs≦rl; and the thickness t of the swollen portion of the emission tube was one of two conditions of 2 mm and 4 mm. The calculations were carried out on 216 conditions in total, including a hollow true sphere that satisfies rs=rl.

FIG. 4 is a graph showing exemplary results of calculation. The calculation results shown in FIG. 4 were obtained when the lamp power W was 200 W, the operating pressure P was 350 atm, the shorter radius rs of the emission tube inner space was 1.5 mm, the longer radius r1 of the emission tube inner space was 1.5 mm, 2.5 mm, 3.5 mm or 4.5 mm and the thickness t was 2 mm.

In the graph shown in FIG. 4, the abscissa represents the thickness position [mm], which is measured with the origin of the model shown in FIG. 3 defined as zero and which represents the distance (or position) from the origin along a line extending from the inner surface of the emission tube toward the outer surface thereof. On the other hand, the ordinate represents the stress [N/mm²] (i.e., the sum of the thermal stress and the pressure-induced stress) when the lamp is lit. In this case, a positive stress represents a tensile stress while a negative stress represents a compressive stress.

As can be seen from FIG. 4, even if each of the lamp power W, operating pressure P, shorter radius rs of the emission tube inner space, and thickness t of the swollen portion of the emission tube remains the same but if the longer radius rl of the emission tube inner space changes, then the stress distribution changes. The stress value depends on the longer radius rl of the emission tube inner space most heavily on the inner surface of the emission tube.

Even when the conditions were defined differently from those producing the results shown in FIG. 4, the results tended to be similar to those shown in FIG. 4. For example, the calculation results shown in FIG. 5 were obtained when the lamp power W was 150 W, the operating pressure P was 450 atm, the shorter radius rs of the emission tube inner space was 1.5 mm, the longer radius rl of the emission tube inner space was 1.5 mm, 2.5 mm, 3.5 mm or 4.5 mm and the thickness t was 4 mm. As shown in FIG. 5, stress distributions similar to those shown in FIG. 4 were observed.

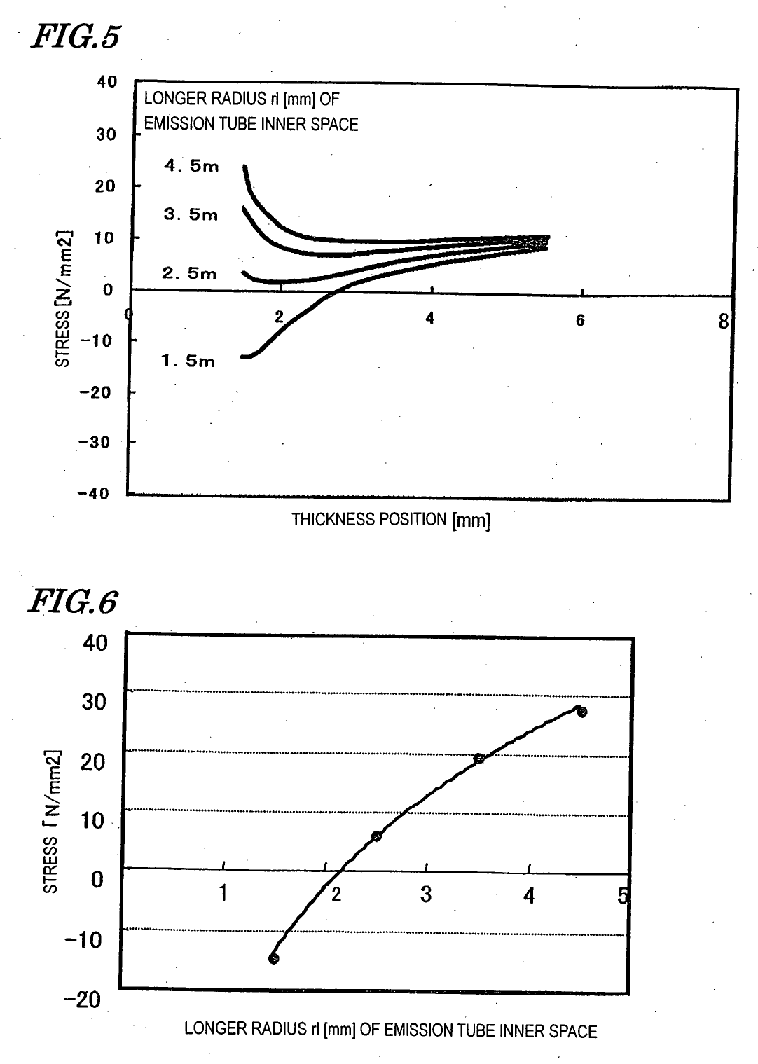

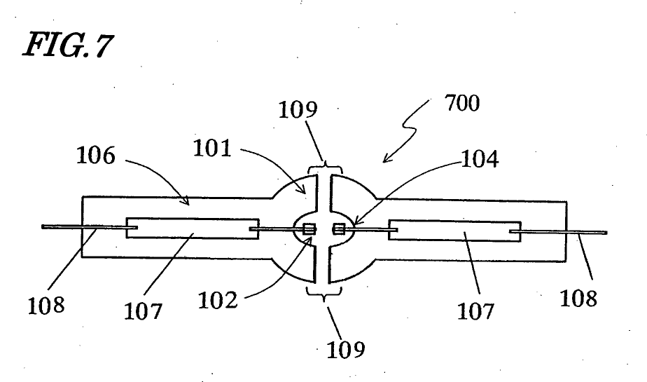

FIG. 6 is a graph obtained based on the data shown in FIG. 4 and shows the rl dependence of the stress on the inner surface of the emission tube (at the thickness position of 1.5 mm). In FIG. 6, the solid curve represents a regression curve. Accordingly, when the lamp power P, operating pressure P, shorter radius rs of the emission tube inner space and thickness t of the swollen portion of the emission tube are fixed, a target longer radius rl of the emission tube inner space, at which the stress on the inner surface of the emission tube becomes equal to a desired value, can be obtained. All other calculation results were also classified in a similar manner.

On each of the lamps Nos. 1 through 10 shown in Table 1, the stress value on the inner surface of the emission tube was calculated by applying the FEM program to the respective parameters including the lamp power P, operating pressure P, shorter radius rs of the emission tube inner space, longer radius rl of the emission tube inner space and thickness t of the swollen portion of the emission tube. The results of the calculations and breakage tests that were carried out at that time are shown in the following Table 2:

TABLE 2

| | Lamp No. | | | | | | | | | | |
|---|---|---|---|---|---|---|---|---|---|---|---|
| | 1 | 2 | 3 | 4 | 5 | 6 | 7 | 8 | 9 | 10 | 11 |
| Stress | 5.45 | 1.32 | 5.36 | 1.95 | 10.48 | 4.46 | −13.21 | −5.86 | 10.32 | −7.28 | −5.31 |
| [N/m²] | | | | | | | | | | | |
| Result | X | ◯ | ◯ | ◯ | X | ◯ | ◯ | ◯ | X | ◯ | ◯ |

As can be seen from Table 2, the breakage occurs when the stress placed on the inner surface of the swollen portion of the emission tube is around 5 N/mm². In other words, the breakage can be avoided with more certainty if the stress placed on the inner surface of the swollen portion of the emission tube can be reduced to 5 N/mm² or less.

Thus, using all of the results of previously performed calculations, a multiple regression formula for reducing the stress on the inner surface of the swollen portion of the emission tube to 5 N/mm² or less was obtained. In this case, rl was supposed to be the target variable and W, P, rs and t were used as explanatory variables.

For example, as for the lamp associated with the graph shown in FIG. 6, the regression curve shows that rl at which a stress of 5 N/mm² was placed on the inner surface of the swollen portion of the emission tube was 2.46 mm. As already described for the graph shown in FIG. 4, this is a value associated with the lamp having W of 200 W, an operating pressure P of 350 atm, a shorter radius rs of the emission tube inner space of 1.5 mm, and a thickness t of 2 mm. All of these sets should be extracted and subjected to multiple regression analysis.

As a multiple regression formula for reducing the tensile stress on the inner surface of the swollen portion of the emission tube to 5 N/mm² or less, the following Equation 4 was obtained:

rl≦0.0103×W−0.00562×P−0.316×rs+0.615×t+1.93 [Equation 4]

The multiple regression analysis had a coefficient of multiple correlation of 0.90. That is to say, it was discovered that a result obtained by the FEM calculation could be represented sufficiently accurately by a theoretical value calculated by Equation 4.

In the present invention, a high-pressure mercury-vapor discharge lamp is designed so as to satisfy the lamp power W≧150 W, the operating pressure P≧250 atm and the glass thickness t≦5 mm and also satisfy Equation 4.

By combining a lamp power W, an operating pressure P, a shorter radius rs of the emission tube inner space, a thickness t of the swollen portion of the emission tube and a longer radius rl of the emission tube inner space so as to satisfy Equation 4, even if the lamp power W and operating pressure P rise, it is still possible to minimize the phenomenon that the lamp is vertically split into two from a point on the swollen portion of the emission tube at an early stage of the lamp life. However, to improve the utility of the lamp, the life of the lamp also needs to be extended.

Thus, a life test was carried out on the eleven types of lamps shown in Table 1. Specifically, while an alternating lighting life test was performed with each lamp lit up to 1,000 hours, it was observed with the eyes how the quartz glass emission tube was broken or damaged extremely during the lighting test. The test results are shown in the following Table 3. Also, based on the temperature distribution that was obtained at the time of the FEM calculation described above, the temperature on the inner surface of the swollen portion of the emission tube (i.e., corresponding to the upper portion for horizontal lighting) was calculated for each lamp. The results are also shown in the following Table 3:

TABLE 3

| | Lamp No. | | | | | | | | | | |
|---|---|---|---|---|---|---|---|---|---|---|---|
| | 1 | 2 | 3 | 4 | 5 | 6 | 7 | 8 | 9 | 10 | 11 |
| Surface | 1509 | 1493 | 1587 | 1599 | 1591 | 1657 | 1773 | 1686 | 1863 | 1742 | 1644 |
| temperature | | | | | | | | | | | |
| ° C. | | | | | | | | | | | |
| Life test | — | ◯ | ◯ | ◯ | — | Δ | X | ◯ | — | X | ◯ |
| result | | | | | | | | | | | |

where the life of each lamp was judged “◯” if the lamp was deformed only slightly, “X ” if the lamp was so deformed as to be broken, and “A” if the lamp was deformed but not broken.

Next, it will be described how to calculate the temperature on the inner surface of the swollen portion of the emission tube based on the temperature distribution that was obtained beforehand at the time of the FEM calculation. Specifically, the temperatures T on the inner surface of the swollen portion of the emission tube were extracted from the 216 types of calculated temperature distributions described above and a multiple regression formula was obtained by performing a multiple regression analysis with the temperature T used as an objective variable and W, rs, rl and t used as descriptive variables as described above. Since the resultant thermal energy is directly defined on the inner surface of the emission tube as described above, the temperature T does not depend on the operating pressure P of the mercury vapor. The resultant multiple regression formula was as follows:

T=4.47×W−244×rs−111×rl−40.2×t+1788 [Equation 5]

The multiple regression analysis had a multiple correlation coefficient of 0.96. According to the results shown in Table 3, which were obtained by Equation 5, it can be seen that the temperature on the inner surface of the swollen portion of the emission tube would have a threshold value of about 1,650° C. that determines the life characteristic (i.e., over which the life test result is unlikely to be “◯”). This temperature of 1,650° C. is close to the softening point of quartz glass as is said often. It is believed that the lamp is normally deformed early at such a temperature. In this case, however, the compressive stress being produced on the top of the inner surface simultaneously is believed to reduce the deformation (as for lamps Nos. 8 and 11).

Thus, in accordance with the preferred combination of parameters shown by Equation 4 and the preferred temperature of 1,650° C. or less on the inner surface of the swollen portion, the following Equation 6 was obtained from Equation 5:

T=4.47×W−244×rs−111×rl−40.2×t+1788≦1650 [Equation 6]

By further modifying this Equation 6, the following Equation 7 was obtained:

244×rs+111×rl+40.2×t24 4.47×W+138 [Equation 7]

By appropriately determining the lamp power W, operating pressure P, shorter radius rs of the emission tube inner space, thickness t of the swollen portion of the emission tube and longer radius rl of the emission tube inner space so as to satisfy Equations 4 and 7 at the same time, even if the lamp power W and operating pressure P both increase, the phenomenon that the lamp splits into two from a point on the swollen portion of the emission tube at an early stage of lamp life can be avoided with more certainty and the lamp life can be extended easily.

If the lamp power W and operating pressure P are low, the tensile stress on the inner wall surface of the swollen portion of the emission tube can be reduced to 5 N/mm² or less relatively easily. Stated otherwise, if the operating pressure W is relatively high (i.e., 150 W or more and 200 W or more), then the pressure-induced stress on the inner surface of the swollen portion of the emission tube (see FIG. 2) increases so much that it becomes very difficult to reduce the tensile stress on the inner wall surface of the swollen portion of the emission tube to 5 N/mm² or less.

On the other hand, the difference between the minimum thermal stress on the inner surface and the maximum thermal stress on the outer surface is determined by the difference in temperature between the two surfaces. To create this temperature difference within a lamp without changing the thermal energy applied, the thickness needs to be increased. If the operating pressure is relatively low, then the pressure-induced stress on the inner surface of the swollen portion of the emission tube (i.e., the tensile stress) is small. Accordingly, there is not so much need to apply a compressive thermal stress to secure sufficient strength for the emission tube, and therefore, the thickness t does not always have to be increased. In addition, if the lamp power W is low, then just a small quantity of energy is dissipated as heat. Thus, the temperature on the inner surface of the emission tube rarely reaches the vicinity of the softening temperature, and the lamp can be designed in any shape with a lot of freedom. In contrast, if the lamp power W becomes 150 watts or more and if the operating pressure P becomes 250 atm or more, then the pressure-induced stress on the inner surface of the swollen portion of the emission tube (i.e., the tensile stress) increases. Accordingly, the tensile stress needs to be relaxed with the application of a thermal stress. However, the thickness t of the emission tube should not exceed 5 mm. This is because the size and weight of the lamp will not be able to be decreased and the transmittance of the glass will decrease in that case.

Thus, as the lamp power W and operating pressure P of a high-pressure mercury-vapor discharge lamp increase, the degree of freedom in design decreases and it becomes more and more difficult to provide a safe lamp with a long life. Accordingly, the present invention will become even more effective in the near future.

It should be noted that the results of calculations and experiments described above were obtained when the lamp power W was 150 watts or more. However, the present invention will be even more effective if the lamp power W is 200 watts or more. Furthermore, if the operating pressure P is 250 atm or more, then cracks will be produced more easily in the boundaries between the emission tube and the side-tube portions. To minimize such cracking, the structure of the second preferred embodiment to be described later is preferably adopted. By adopting the structure as will be described for the second embodiment, the present invention achieves particularly beneficial effects when the breakage at the center of the swollen portion is a most serious problem.

Embodiment 2

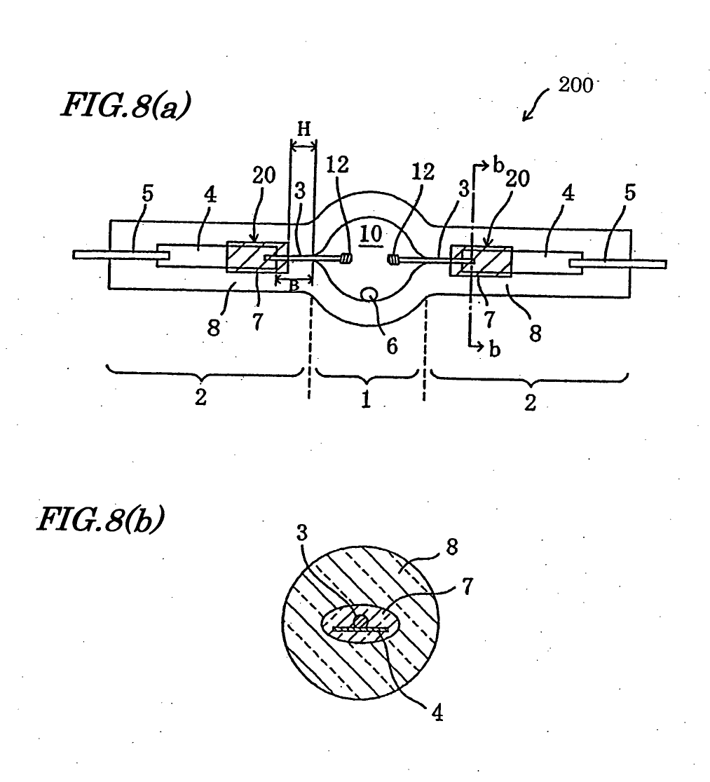

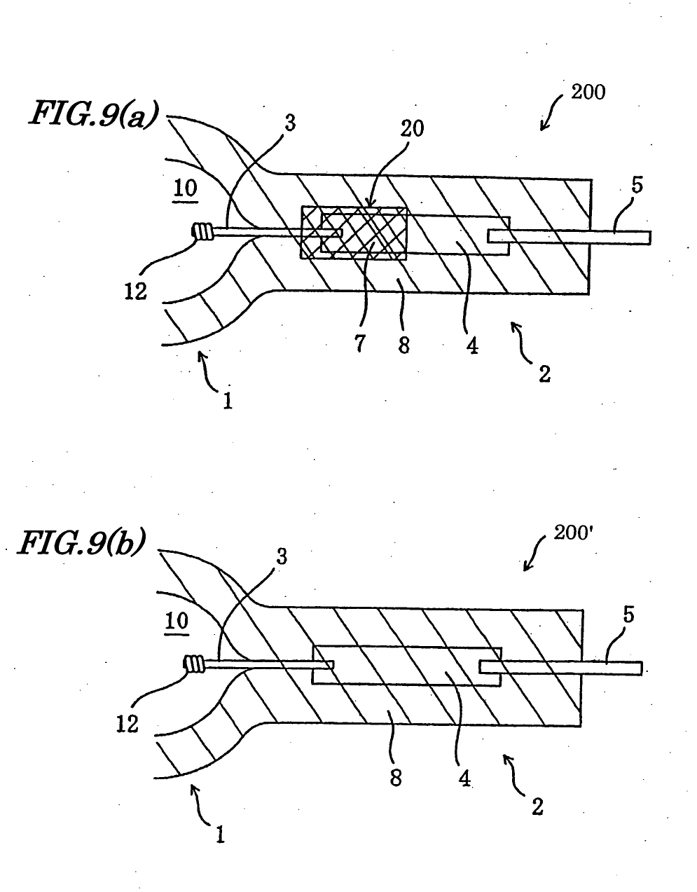

Hereinafter, a high-pressure mercury-vapor discharge lamp according to a second embodiment of the present invention will be described with reference to FIGS. 8 through 10.

The high-pressure mercury-vapor discharge lamp of this preferred embodiment has not only the structure that is designed by the technique as described for the first preferred embodiment but also an additional structure for minimizing the cracking at the boundaries between the emission tube and the side-tube portions.

FIGS. 8(a) and 8(b) schematically illustrate the structure of a high-pressure mercury-vapor discharge lamp 200 according to this preferred embodiment. The lamp 200 of this preferred embodiment includes an emission tube 1, in which a fluophor 6 is sealed, and two side-tube portions 2 extending from the emission tube 1. FIG. 8(a) schematically illustrates an overall arrangement of the lamp 200, and FIG. 8(b) schematically shows a cross-sectional structure of the side-tube portion 2 as taken on the line b-b shown in FIG. 8(a) and viewed from the emission tube 101.

The side-tube portions 2 of the lamp 200 function as “sealing portions” for keeping the inner space 10 of the emission tube 1 airtight. The lamp 200 is a double-ended lamp including the two side-tube portions 2.

In this preferred embodiment, each of the side-tube portions 2 includes a substantially cylindrical first glass portion 8 extending from the emission tube 1 and a second glass portion 7, which is provided so as to fill at least a part of the inside (i.e., the core) of the first glass portion 8. The side-tube portion 2 further has a site 7 to which a compressive stress is applied. In this preferred embodiment, the site to which the compressive stress is applied corresponds to the second glass portion 7. As shown in FIG. 8(b), each side-tube portion 2 has a substantially circular cross section and a metal portion 4 for supplying the lamp power is provided inside of the side-tube portion 2. This metal portion 4 is partially in contact with the second glass portion 7. In this preferred embodiment, the metal portion 4 is located at the center of the second glass portion 7. The second glass portion 7 is located at the center of the side-tube portion 2 and has its outer surface covered with the first glass portion 8.

When the side-tube portions 2 were observed by subjecting the lamp 200 of this preferred embodiment to a strain measurement by a sensitive color plate method that utilizes the photoelastic effects, it was confirmed that some compressive stress was present in the regions corresponding to the second glass portions 7. In the strain measurement by the sensitive color plate method, the strain (or stress) in none of the circular cross sections of the side-tube portions 2 can be gauged with the shape of the lamp 200 maintained. However, a compressive stress was actually sensed in the region corresponding to the second glass portion 7. This means that the compressive stress was applied to all or most of the second glass portion 2, to the boundary portion between the second and first glass portions 7 and 8, to a part of the second glass portion 7 which was close to the first glass portion 8, to a part of the first glass portion 8 which was close to the second glass portion 7, or a combination thereof. In any case, the compressive stress was applied to somewhere inside of the side-tube portion 2. Also, in this measurement, the stress (or strain) which is compressed in the length direction of the side-tube portion 2 is obtained as an integral thereof.

In each side-tube portion 2, the first glass portion 8 includes at least 99 wt % of SiO₂ and may be made of quartz glass, for example. On the other hand, the second glass portion 7 includes at most 15 wt % of Al₂O₃ and/or at most 4 wt % of B and SiO₂ and may be made of Vycor glass. If Al₂O₃ and/or B are/is added to SiO₂, the softening point of glass can be decreased. Accordingly, the softening point of the second glass portion 7 is lower than that of the first glass portion 8. The “Vycor glass” (product name) is a sort of glass which has a lower softening point by mixing an additive with quartz glass and which is processible more easily than quartz glass. The Vycor glass may be prepared by thermally and chemically treating glass borosilicate such that its characteristic is close to that of quartz, for example. The Vycor glass may have a composition including 96.5 wt % of silica (SiO₂), 0.5 wt % of alumina (Al₂O₃), and 3 wt % of boron (B), for example. In this preferred embodiment, the second glass portion 7 is a glass tube made of the Vycor glass. Alternatively, the glass tube of Vycor glass may be replaced with a glass tube including 62 wt % of SiO₂, 13.8 wt % of Al₂O₃ and 23.7 wt % of CuO.

The compressive stress applied to a part of the side-tube portion 2 may be substantially greater than zero (i.e., more than 0 kgf/cm²). It should be noted that the compressive stress has such a value when the lamp is not yet lit. Due to the presence of this compressive stress, the lamp can have a higher pressure resistance than a conventional structure. This compressive stress is preferably at least about 10 kgf/cm² (approximately 9.8×10⁵ N/m²) and at most about 50 kgf/cm² (approximately 4.9×10⁶ N/m²). The reasons are as follows. Specifically, if the compressive stress is less than 10 kgf/cm², then the compressive strain might be too weak to increase the pressure resistance of the lamp sufficiently. On the other hand, even though the lamp preferably has a compressive stress that is higher than 50 kgf/cm², no glass material is actually available to achieve such a high compressive stress. However, even if the compressive stress is less than 10 kgf/cm² but substantially greater than zero, the resultant pressure resistance can still be higher than that of the conventional structure. Also, when a practical material achieving a compressive stress that is higher than 50 kgf/cm² is developed, the second glass portion 7 may have a compressive stress of more than 50 kgf/cm².

According to the results obtained by examining the lamp 200 with a strain tester, a strain boundary region 20, produced due to the difference in compressive stress between the first and second glass portions 8 and 7, is believed to be present around the boundary between the first and second glass portions 8 and 7. This is believed to mean that the compressive stress should be present exclusively in the second glass portion 7 (or around the outer periphery of the second glass portion 7) and that no so much (or even almost no) compressive stress has been transmitted from the second glass portion 7 to the first glass portion 8. The difference in compressive stress between these glass portions 8 and 7 may fall within the range of about 10 kgf/cm² to about 50 kgf/cm², for example.

The emission tube 1 of the lamp 200 has an eyeball shape and may be made of quartz glass as well as the first glass portion 8. To realize a high-pressure mercury lamp (or an extra-high-pressure mercury lamp, in particular) exhibiting excellent characteristics including a long life, high-purity quartz glass including a low level (e.g., 1 ppm or less) of alkaline metal impurities is preferably used as the quartz glass for the emission tube 1. Naturally, quartz glass including a normal level of alkaline metal impurities may also be used. The emission tube 1 may have an outside diameter of about 5 mm to about 20 mm, for example, and a glass thickness of about 1 mm to about 5 mm, for example. The internal discharge space 10 of the emission tube 1 may have a volume of about 0.01 cc to about 1 cc (i.e., 0.01 cm³ to 1 cm³). In this preferred embodiment, an emission tube 1 with an outside diameter of about 9 mm, an inside diameter of about 4 mm, and an internal discharge space having a volume of about 0.06 cc may be used.

A pair of electrode bars (electrodes) 3 is arranged inside of the emission tube 1 so as to face each other. The ends of the electrode bars 3 are arranged inside of the emission tube 1 so as to be spaced apart from each other by a distance (i.e., the arc length) D of about 0.2 mm to about 5 mm (e.g., 0.6 mm to 1.0 mm). Each of these electrode bars 3 is made of tungsten (W). To decrease the temperature at the end of the electrode bar 3 while the lamp is operating, a coil 12 is wound around the end of the electrode bar 3. In this preferred embodiment, a tungsten coil is used as the coil 12. Alternatively, a thorium-tungsten coil may also be used. In the same way, the electrode bars 3 may also be thorium-tungsten bars, not just tungsten bars.

Mercury 6 is sealed as a fluophor in the emission tube 1. If the lamp 200 should operate as an extra-high-pressure mercury lamp, then the mercury 6 sealed in the emission tube 1 preferably includes at least about 200 mg/cc (e.g., at least 220 mg/cc, at least 230 mg/cc or at least 250 mg/cc), and preferably at least 300 mg/cc (e.g., 300 mg/cc to 500 mg/cc) of mercury, 5 kPa to 30 kPa of rare gas (e.g., argon) and a small amount of halogen if necessary.

The halogen sealed in the emission tube 1 performs a halogen cycle of returning W (tungsten), which has evaporated from the electrode bars 3 during the operation of the lamp, to the electrode bars 3 again, and may be bromine, for example. The halogen to be sealed in does not have to be included as an element but may also be a halogen precursor (or compound). In this preferred embodiment, the halogen is introduced as CH₂Br₂ into the emission tube 10. Also, in this preferred embodiment, the amount of CH₂Br₂ to be sealed in is about 0.0017 mg/cc to about 0.17 mg/cc, which is equivalent to a halogen atomic density of about 0.01 μmol/cc to about 1 μmol/cc during the operation of the lamp. The lamp 200 may have a pressure resistance (or operating pressure) of 20 MPa or more (e.g., about 30 MPa to about 50 MPa or even more). Also, the bulb wall loading may be about 60 W/cm² or more, the upper limit of which is not particularly defined. For example, a lamp with a bulb wall loading of about 60 W/cm² to about 300 W/cm² (preferably about 80 W/cm² to about 200 W/cm²) is realized. By providing a cooling means, a bulb wall loading of about 300 W/cm² or more may also be achieved. It should be noted that the rated power may be 150 W (corresponding to a bulb wall loading of about 130 W/cm²), for example.

Each electrode bar 3, one end of which is located inside of the discharge space 10, is welded with the metal foil 4, which is provided within the side-tube portion 2 and at least a portion of which is located within the second glass portion 7. In the arrangement shown in FIG. 8, a portion including the connecting part between the electrode bar 3 and the metal foil 4 is covered with the second glass portion 7. In the arrangement shown in FIG. 8, the second glass portion 7 may have a length of about 2 mm to about 20 mm (e.g., 3 mm, 5 mm or 7 mm) as measured along the length of the side-tube portion 2, and the second glass portion 7 sandwiched between the first glass portion 8 and the metal foil 4 may have a thickness of about 0.01 mm to about 2 mm (e.g., 0.1 mm). The distance H from the end surface of the second glass portion 7 (which is opposed to the emission tube 1) to the discharge space 10 of the emission tube 1 may be about 0 mm to about 6 mm (e.g., 0 mm to about 3 mm or 1 mm to 6 mm). If the second glass portion 7 should not be exposed within the discharge space 10, then the distance H is greater than 0 mm (e.g., 1 mm or more). The distance B from the end surface of the metal foil 4 (which is opposed to the emission tube 1) to the discharge space 10 of the emission tube 1 (i.e., the length of a portion of the electrode bar 3 which is embedded in the side-tube portion 2 by itself) may be about 3 mm, for example.

As described above, the side-tube portion 2 has a substantially circular cross section, substantially at the center of which the metal foil 4 is provided. The metal foil 4 may be a rectangular piece of molybdenum (Mo) foil and may have a width (i.e., a shorter-side length) of about 1.0 mm to about 2.5 mm (preferably about 1.0 mm to about 1.5 mm) and a thickness of about 15 μm to about 30 μm (preferably about 15 μm to about 20 μm). The ratio of the thickness to the width thereof is approximately 1:100. Also, the metal foil 4 may have a length (i.e., a longer-side length) of about 5 mm to about 50 mm, for example.

An external lead 5 is welded so as to be opposed to the electrode bar 3. That is to say, the external lead 5 is connected to the other side of the metal foil 4, which is opposite to its side connected to the electrode bar 3. One end of the external lead 5 extends out of the side-tube portion 2. By electrically connecting the external lead 5 to a lighting circuit (not shown), the pair of electrode bars 3 is electrically connected to the lighting circuit. The side-tube portion 2 performs the function of keeping the discharge space 10 inside of the emission tube 1 airtight by press-fitting the metal foil 4 with the glass portions 7 and 8 within the sealing portion. The mechanism of sealing achieved by the side-tube portion 2 will be described briefly.

The material of the glass portions of the side-tube portion 2 and molybdenum as the material of the metal foil 4 have mutually different thermal expansion coefficients. Accordingly, considering their thermal expansion coefficients, these two portions cannot be sealed up together. In this arrangement (i.e., foil sealing), however, the metal foil 4 is deformed plastically under the pressure applied from the glass portions of the sealing portion and the gap between them can be filled up. As a result, the glass portions of the side-tube portion 2 can be press-fit against the metal foil 4 and the emission tube 1 can be sealed up with the side-tube portion 2. That is to say, the side-tube portion 2 is sealed up by foil sealing, which is achieved by press-fitting the glass portions of the side-tube portion 2 against the metal foil 4. In this preferred embodiment, the second glass portion 7 is provided so as to have a compressive strain, thus increasing the reliability of this sealing structure.

Next, the compressive strain in the side-tube portion 2 will be described. FIGS. 9(a) and 9(b) schematically show the distributions of compressive strains in the length direction (i.e., electrode axis direction) of the side-tube portion 2. Specifically, FIG. 9(a) shows a compressive strain distribution in the lamp 200 including the second glass portion 7, while FIG. 9(b) shows a compressive strain distribution in a lamp 200′ including no second glass portion 7 as a reference example.

In the side-tube portion 2 shown in FIG. 9(a), the compressive stress (or compressive strain) is present in the region corresponding to the second glass portion 7 (i.e., hatched area), while the compressive stress in the first glass portion 8 (i.e., area with the diagonal lines) is substantially zero. In the side-tube portion 2 with no second glass portion 7 on the other hand, no compressive strain is present locally and the compressive stress in the first glass portion 8 is substantially zero as shown in FIG. 9(b).

The present inventors actually quantified the strain of the lamp 200 to discover that the compressive stress was present in the second glass portion 7 of the side-tube portion 2. Such a strain can be quantified by a sensitive color plate method that utilizes the photoelastic effect. According to this method, a portion with a strain (or stress) looks like having a different color, and therefore, the magnitude of the strain can be quantified by comparing the color with that of a strain standard. That is to say, the stress can be calculated by reading an optical path difference that has the same color as that of the strain to be measured. A strain tester SVP-200 (produced by Toshiba Corp.) was used as a gauge for quantifying the strain. By using this strain tester, the magnitude of the compressive strain in the side-tube portion 2 can be obtained as an average stress applied to the side-tube portion 2.

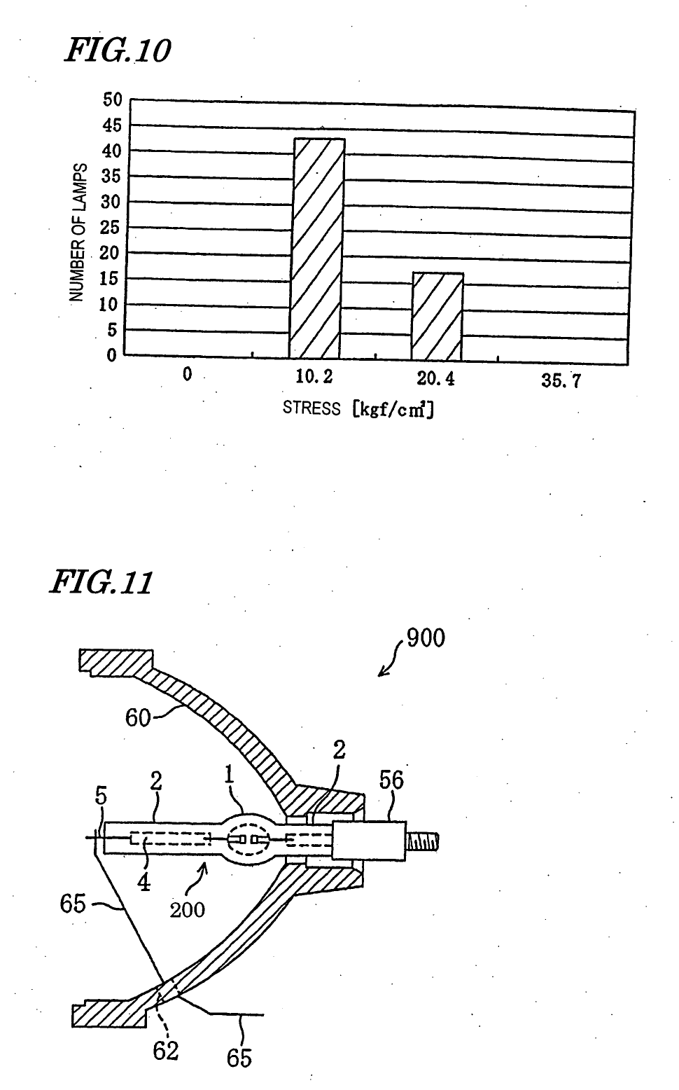

The present inventors measured the distance L over which the light being transmitted through the side-tube portion 2 should go, i.e., the outside diameter L of the side-tube portion 2, and read the optical path difference R by the color of the side-tube portion 2 while the strain was being measured with a strain standard. As the photoelastic constant C, the photoelastic constant of 3.5 of quartz glass was used. Stress values, which were calculated by substituting these values into the equation described above, are shown as the bar graph in FIG. 10.

As shown in FIG. 10, the number of lamps with a stress of 0 kgf/cm² was 0, the number of lamps with a stress of 10.2 kgf/cm² was 43, the number of lamps with a stress of 20.4 kgf/cm² was 17, and the number of lamps with a stress of 35.7 kgf/cm² was 0.

As for the reference lamps 200′ on the other hand, all of the lamps under measurement had a stress of 0 kgf/cm². According to the principle of measurement, the compressive stress of the side-tube portion 2 was calculated from the average stress applied to the side-tube portion 2. However, judging from the results shown in FIG. 10, it is easy to make a conclusion that a compressive stress is applied to a part of the side-tube portion 2 by providing the second glass portion 7. This is because no compressive stress was present in the side-tube portion 2 of the reference lamp 200′. FIG. 10 shows discrete stress values because the optical path differences, which were read with the strain standard, were also discrete. Accordingly, the discrete stress values were obtained in accordance with the strain measuring principle of the sensitive color plate method. For example, stresses with intermediate values between 10.2 kgf/cm² and 20.4 kgf/cm² should have actually been present. Even so, however, it is still true that a predetermined amount of compressive stress was present either on the second glass portion 7 or around the outer periphery of the second glass portion 7.

In this measurement, the stress was observed in the length direction of the side-tube portion 2 (i.e., the direction in which the electrode axis 3 extends). However, this does not mean that no compressive stress is present in any other direction. For example, to see if there is a compressive stress along the radius (i.e., from its center toward the periphery) or around the periphery (e.g., in a clockwise direction) of the side-tube portion 2, either the emission tube 1 or the side-tube portion 2 needs to be cut off. However, once the emission tube 1 or side-tube portion 2 is cut off, the compressive stress of the second glass portion 7 is relaxed. Accordingly, it is only in the length direction of the side-tube portion 2 that the compressive stress can be measured without cutting the lamp 2 off. For that reason, the present inventors quantified the compressive stress at least in that direction.

In the lamp 200 of this preferred embodiment, a compressive strain (i.e., at least a compressive strain in the length direction) is present in the second glass portion 7, which is provided so as to fill at least a part of the inside space of the first glass portion 8, thus increasing the pressure resistance of a high-pressure discharge lamp. In other words, the lamp 200 of this preferred embodiment shown in FIGS. 8 and 9(a) can have a higher pressure resistance than the lamp 200′ of the reference example shown in FIG. 9(b). Thus, the lamp 200 of this preferred embodiment shown in FIG. 8 can be operated at an operating pressure of 30 MPa or more, which exceeds the conventional highest possible operating pressure of about 20 MPa.

Embodiment 3

Hereinafter, a lamp unit according to an embodiment of the present invention will be described with reference to FIG. 11. In this preferred embodiment, the lamp 100 or 200 described above is combined with a reflective mirror to make up a lamp with a mirror, or a lamp unit.

FIG. 11 schematically illustrates a cross section of a lamp 900 with a mirror, which includes a lamp 200 according to the preferred embodiment of the present invention described above. The lamp 900 with the mirror includes the lamp 200 having the substantially eyeball-shaped emission tube 1 and the pair of side-tube portions 2, and a reflective mirror 60 for reflecting the light that has been emitted from the lamp 200. Although the lamp 200 is used for illustrative purposes, the lamp 100 may also be used instead. Optionally, the lamp 900 with the mirror may further include a lamp house for supporting the reflective mirror 60 thereon. In this case, even a unit including such a lamp house is also a lamp unit according to this preferred embodiment.

The reflective mirror 60 is designed so as to reflect the light that has been radiated from the lamp 100 and turn the light into a bundle of parallel rays, a bundle of condensed rays being converged onto a predetermined tiny area, or a bundle of diverged rays equivalent to that diverged from a predetermined tiny area, for example. A parabolic mirror or an ellipsoidal mirror may be used as the reflective mirror 60.

In this preferred embodiment, a base 56 is attached to one of the two side-tube portions 2 of the lamp 200, and the external lead 5 extending from the side-tube portion 2 is electrically connected to the base 56. The side-tube portion 2 and the reflective mirror 60 may be bonded and combined together with an inorganic adhesive (e.g., cement). An extended lead wire 65 is electrically connected to the external lead 5 of the other side-tube portion 2 that is located in the front opening of the reflective mirror 60. The extended lead wire 65 is extended from the lead 5 to the outside of the reflective mirror 60 by way of the lead wire opening 62 of the reflective mirror 60. For example, a front glass shield may be attached to the front opening of the reflective mirror 60.

Such a lamp with a mirror or such a lamp unit may be attached to an image projection system such as a projector including a liquid crystal display or a digital micro-mirror device (DMD), and may be used as a light source for an image projection system. Also, by combining such a lamp with a mirror or such a lamp unit with an optical system including an image display device (e.g., a DMD panel or a liquid crystal panel), an image projection system can be obtained. For example, a projector including a DMD (e.g., a digital light processing (DLP) projector) or a reflective projector having a liquid crystal on silicon (LCOS) structure can be provided. Furthermore, the lamp or lamp unit of this preferred embodiment can be used not just as a light source for image projection systems but also as a light source for a UV ray stepper, lighting for player stadiums, headlights for a car or a light source for a projector to light up a road sign, for example.

### Industrial Applicability

The present invention can set design guidelines that are optimized for increasing the lamp power and the operating pressure in the emission tube as compared with conventional ones. Thus, the unwanted phenomenon that a lamp is vertically split into two from a point on the swollen portion of the emission tube at an early stage of the life of a lighted lamp can be minimized and the life of the lamp can be extended as well. At the same time, the performance of the lamp itself can also be improved in terms of the optical output and efficiency. If such a lamp is used in projector, then the performance of the projector can also be improved. For example, since the breakage of the lamp can be minimized, a higher degree of safety is ensured. The extended lamp life promises increased reliability in long-time operation. The less frequent lamp exchange can decrease the maintenance cost significantly. In addition, the higher optical output can increase the screen illuminance. Furthermore, the increased efficiency can save a significant quantity of energy. In this manner, immeasurable beneficial effects are achieved by the present invention in these and various other respects.

1. A high-pressure mercury-vapor discharge lamp comprising:
an emission tube, which is made of quartz glass and which has a substantially ellipsoidal inner space;
a gas, which is sealed in the inner space of the emission tube and which includes at least mercury and a rare gas; and
at least two electrodes, which are arranged in the inner space of the emission tube so as to face each other,
wherein the lamp satisfies W≧150 watts, P≧250 atm, t≦5 mm and rl≦0.0103×W−0.00562×P−0.316×rs+0.615×t+1.93, where W [watts] is the power of the lamp during its lighting operation, P [atm] is an operating pressure in the inner space of the emission tube, rs [mm] is the shorter radius of the inner space, rl [mm] is the longer radius of the inner space (where rl≧rs), and t [mm] is the thickness of a swollen portion that defines the inner space.

2. The high-pressure mercury-vapor discharge lamp of claim 1, wherein the lamp has an arc length of 2 mm or less.

3. The high-pressure mercury-vapor discharge lamp of claim 1, wherein the lamp has a tensile stress of 5 N/mm² or less on an inner wall surface of the swollen portion of the emission tube during the lighting operation.

4. The high-pressure mercury-vapor discharge lamp of claim 1, wherein the lamp satisfies W≧200 watts.

5. The high-pressure mercury-vapor discharge lamp of claim 1, wherein the lamp further satisfies the relationship 244×rs+111×rl+40.2×t≧4.47×W+138.

6. The high-pressure mercury-vapor discharge lamp of claim 1, further comprising two side-tube portions, which are coupled to the emission tube,
wherein each of the two side-tube portions includes a columnar portion that extends from the emission tube in an arc length direction, and
wherein the columnar portion includes a substantially cylindrical first glass portion and a second glass portion, which is provided so as to fill at least a part of the inside of the first glass portion, and has a site to which compressive stress is applied.

7. The high-pressure mercury-vapor discharge lamp of claim 6, wherein the site to which the compressive stress is applied is one of
the second glass portion,
a boundary between the second and first glass portions,
a part of the second glass portion, which is close to the first glass portion, and
a part of the first glass portion, which is close to the second glass portion.

8. The high-pressure mercury-vapor discharge lamp of claim 6, wherein a strain resulting from a difference in stress between the first and second glass portions is present in the vicinity of the boundary between the first and second glass portions.

9. The high-pressure mercury-vapor discharge lamp of claim 6, wherein the compressive stress is applied at least partially along the length of the side-tube portions.

10. A high-pressure mercury-vapor discharge lamp comprising:
an emission tube, which is made of quartz glass and which has a substantially ellipsoidal inner space;
a gas, which is sealed in the inner space of the emission tube and which includes at least mercury and a rare gas; and
at least two electrodes, which are arranged in the inner space of the emission tube so as to face each other,
wherein the lamp satisfies W≧150 watts, P≧250 atm and t≦5 mm, where W [watts] is the power of the lamp during its lighting operation, P [atm] is an operating pressure in the inner space of the emission tube, and t [mm] is the thickness of a swollen portion that defines the inner space, and
wherein the lamp has a tensile stress of 5 N/mm² or less on an inner wall surface of the swollen portion of the emission tube during the lighting operation.

11. A lamp unit comprising:
the high-pressure mercury-vapor discharge lamp of one of claims 1 to 10; and
a reflective mirror for reflecting light that has been emitted from the emission tube of the high-pressure mercury-vapor discharge lamp,
wherein the lamp unit is lit such that the longer radius of the inner space of the emission tube is parallel to ground.
